(19) United States
(12) Patent Application Publication
(10) Pub. No.: US 2017/0373866 A1
(43) Pub. Date: Dec. 28, 2017

(54) METHOD AND SERVICE CENTER FOR COMMUNICATING BROADCAST MESSAGES BETWEEN CLIENTS IN A COMMUNICATION NETWORK

(71) Applicant: SIEMENS AKTIENGESELLSCHAFT, München (DE)

(72) Inventor: Joachim Walewski, Unterhaching (DE)

(21) Appl. No.: 15/543,991

(22) PCT Filed: Jan. 15, 2015
(86) PCT No.: PCT/EP2015/050676

§ 371 Date: Jul. 15, 2017

(51) Int. Cl. H04L 12/18; H04W 4/06; H04W 88/16

(52) U.S. Cl. CPC H04L 12/189; H04W 4/06; H04W 88/16

(57) ABSTRACT

A method for communicating broadcast messages between clients in a communication network having a core mobile network and a number of wireless mobile networks is provided. Each of the clients is coupled to the core mobile network at least by one of the wireless mobile networks. The method includes sending a broadcast message from a sending client of the clients via unicast to a service center of the core mobile network and transmitting the broadcast message from the service center via broadcast to the plurality of clients using at least a subset of the wireless mobile networks.

This application is the National Stage of International Application No. PCT/EP2015/050676, filed Jan. 15, 2015, which is hereby incorporated by reference in its entirety.

### FIELD

The present embodiments relate to communicating broadcast messages between clients in a communication network.

### BACKGROUND

Distributed automation (e.g., energy-automation in medium-voltage grids) relies on effective communication of automation data packages. Many conventional automation protocols rely on layer-2 broadcast mechanisms for at least part of the messages. Mobile-network technology such as Long-Term Evolution (LTE) is currently investigated for potential as wide-area networks (WANs) for distributed automation.

Mechanisms for translating layer-2 broadcast messages into layer-3 multicast packages exist, so that IP-centric technologies such as LTE are in principle suitable. However, in many circumstances, not all automation devices need to hear and, therefore, receive all broadcast messages. One example for this is the avoidance of power tripping in medium-voltage distribution networks. In such a medium-voltage distribution network, the energy-automation devices may hear only the broadcast messages in neighboring secondary substations (e.g., not all of the secondary substations in one medium-voltage branch or open ring).

### SUMMARY AND DESCRIPTION

The scope of the present invention is defined solely by the appended claims and is not affected to any degree by the statements within this summary.

The present embodiments may obviate one or more of the drawbacks or limitations in the related art. For example, communicating broadcast messages in a communication network is improved.

According to a first aspect, a method for communicating broadcast messages between clients in a communication network having a core mobile network and a number N of wireless mobile networks (N≧1) is provided. Each of the clients is coupled to the core mobile network at least by one of the N wireless mobile networks. The method includes sending a broadcast message from a sending client of the clients via unicast to a service center of the core mobile network and transmitting the broadcast message from the service center via broadcast to the plurality of clients using at least a subset of the N wireless mobile networks.

For example, each of the clients includes an automation unit or secondary substation and a modem. The clients may be coupled by a medium-voltage distribution network (e.g., by an open medium-voltage ring). The communication network may be a 3G network, a 4G network, or a 5G network. The service center may include a broadcast multicast service center (BMSC) and a multimedia broadcast multicast service gateway (MBMS-GW).

The method of one or more of the present embodiments enables clients to directly communicate broadcast messages with each other.

As mentioned above, each of the clients includes an automation unit or secondary substation and a modem (e.g., an LTE modem). Thus, according to one or more of the present embodiments, the method may enable differentiated Wide-Area Network (WAN) automation broadcast through the use of LTE multimedia broadcast multicast services.

For example, already existing standard solutions, like 3GPP R9 and later, may be used for separating broadcast traffic from the automation units that may not see each other.

The wireless mobile networks may be radio-access networks. The combination of an LTE modem with other functionalities (e.g., automation) may be user equipment (UE).

According to one or more of the present embodiments, the method may use GOOSE, because the method is well suited for energy-automation broadcast via routable GOOSE. A reason for that is that not all energy-automation units need to hear each other.

Further, according to one or more of the present embodiments, the broadcast areas of different applications may be separated from each other.

In an embodiment, the broadcast message is sent from the sending client over a local gateway or a packet data network gateway (e.g., PDN gateway) to the broadcast multicast service center (BMSC).

According to one or more of the present embodiments, the broadcast message is transmitted from the broadcast multicast service center to the clients (or receiving clients) over the multimedia broadcast multicast service gateway and, for example, over the local gateway or the packet data network gateway.

According to a further embodiment, the method includes allocating each of the clients to one broadcast area of a plurality of broadcast areas covered by the N wireless mobile networks.

This suggested area mechanism allows creating overlapping zones of almost arbitrary topology and of high scalability since a base station, according to current standards, may belong to up to eight broadcast areas per sector. For example, using the 3GPP area-broadcast mechanisms results in low traffic as opposed to an “all-out” broadcast or “unicast-broadcast” solutions such as layer-tunneling (see, e.g., IEC 61850-90-5).

If more than one sector is used for connecting automation units, up to 256 broadcast areas may be supported. An intelligent combination of sectors and, where needed, multiple base stations may thus support a very fine-grain separation of broadcast traffic in an automation network.

According to a further embodiment, the method includes transmitting the broadcast messages received from the sending client being allocated to a certain broadcast area of the plurality of broadcast areas from the service center via broadcast to the further clients allocated to the certain broadcast area.

This provides that from one certain sending client that is allocated to a certain broadcast area, the broadcast message is transmitted from the sending client to the service center via unicast, and then the same broadcast message is transmitted to the further clients allocated to the same certain broadcast area using broadcast.

According to a further embodiment, the method includes filtering the broadcast message that is broadcast to the clients allocated to the certain broadcast area such that the broadcast message reaches all the clients allocated to the certain broadcast area excluding the sending client.

According to one or more embodiments, such a filtering is not used. Then, the sending client may receive the broadcast message that the sending client originated. The sending client may interpret this received broadcast message as a transmission confirmation.

The allocating may be based on mapping indications, identifiers, geographic locations of the clients, or a combination thereof. In the following, these possibilities are provided in detail.

According to a further implementation, the allocating includes sending a mapping indication from a certain client of the clients to the service center, where the mapping indication indicates a certain broadcast area the certain client wants to join. The allocating also includes receiving the mapping indication at the service center, and mapping the certain client to the certain broadcast area using said received mapping indication.

As mentioned above, each of the clients may include an automation unit (or secondary substation) and a modem (e.g., an LTE modem). The mapping indication may be provided in dependence on the automation unit (e.g., in dependence on a certain type of the automation unit). The provided mapping indication may be transferred to the service center using the modem.

According to a further embodiment, the allocating includes sending an identifier (ID) of a certain client of the clients to the service center, receiving the identifier at the service center, and mapping the certain client to a certain broadcast area using the received identifier.

In this embodiment, the certain client may be mapped to the certain broadcast area using the received identifier identifying the automation unit and/or the modem and using a directory. The directory may list the automation units, the modems, and the allocated broadcast areas.

According to a further embodiment, allocating includes providing a geographic location of a certain client of the clients to the service center, receiving the geographic location at the service center, and mapping the certain client to the certain broadcast area using the received geographic location.

According to a further embodiment, the method includes shaping the traffic for the plurality of broadcast areas.

For example, for each of the broadcast areas, the number of subframes may be adjusted within a radio frame dedicated to a respective broadcast area. For example, the number of subframes within the radio frame dedicated to one broadcast area is variable. This may be used for the traffic shaping. If, for example, one broadcast area contains mission-critical automation devices that, in the case of an emergency, produce a lot of traffic (e.g., a GOOSE burst), then this mechanism may be used for an a-priori allocating sufficient bandwidth to this broadcast area. For example, this may be done on a dynamic basis.

Any embodiments of the first aspect may be combined with any embodiment of the first aspect to obtain another embodiment of the first aspect.

According to a second aspect, a service center for communicating broadcast messages between clients in a communication network having a core mobile network and a number N of wireless mobile networks (N≧1) is provided. Each of the clients is coupled to the core mobile network by one of the N wireless mobile networks. The service center includes a receiving unit and a transmitting unit. The receiving unit is configured to receive a broadcast message sent from a sending client of the clients via unicast. The transmitting unit is configured to transmit the broadcast message received from the receiving unit via broadcast to a plurality of the clients using at least a subset of the N wireless mobile networks.

The respective unit (e.g., the receiving unit, the transmitting unit, or the automation unit) may be implemented in hardware and/or in software. If the unit is implemented in hardware, the unit may be embodied as a device (e.g., as a computer or as a processor or as a part of a system such as a computer system). If the unit is implemented in software, the unit may be embodied as a computer program product, as a function, as a routine, as a program code, or as an executable object. For example, the automation unit may be an automation application. The automation unit may be entirely virtual (e.g., software that runs on the same CPU as a layer-2-to-3 translator).

According to a third aspect, a system includes a plurality of clients and a service center of above-mentioned second aspect.

The embodiments and features described with reference to the device apply mutatis mutandis to the method of the present invention.

Further, possible implementations or alternative solutions also encompass combinations of features described above or below with regard to the embodiments that are not explicitly mentioned herein. A person skilled in the art may also add individual or isolated aspects and features to the most basic form of the invention.

The following example may illustrate the functionality of the present embodiments. For the following example, the service center includes a broadcast multicast service center (BMSC) and a multimedia broadcast multicast service gateway (MBMS-GW). Further, the core mobile network is an LTE network. The example includes the following acts 1-8.

1. The LTE network that provides collectivity for the automation units is equipped with the BMSC and the MBMS-GW.

2. The LTE modems that are connected to the broadcast automation units subscribe to broadcast messages from the BMSC.

3. The LTE modem is mapped or allocated to one broadcast area. For this allocation, the following solutions a)-c) may be provided.

a) The LTE modem indicates what broadcast area the LTE modem wants to join. The information for doing so may, for example, be provided by the automation unit the LTE modem serves.
b) The LTE modem only provides an identifier (ID) for the LTE modem or the connected automation unit or units. The MBMS-GW decides, based on this ID, to what broadcast area or broadcast areas the LTE modem and associated automation unit(s) belong. This decision may, for example, be supported by a directory in which the LTE modems and/or the automation units are listed and which also lists the pertinent broadcast areas.
c) The LTE modem provides a geographic location of the LTE modem or, alternatively, the geographic location of the connected automation unit(s). The geographic location may, for example, contain street addresses or GPS coordinates.

4. The BMSC is enabled such that the BMSC may receive broadcast messages from the automation units.

5. The base stations of the LTE network serving the LTE modems are also connected to a local gateway or a PDN gateway.

6. In case the automation messages were originally defined for layer-2 communications: The automation units or a gateway between the automation units and pertinent LTE modems of the automation units are equipped with a “layer-2-to-layer-3 translator” that may also serve as a router.

7. Broadcast-automation messages are sent via unicast to the BMSC. This may, for example, be accomplished via a regular bearer, that terminates at the PDN gateway, and the PDN gateway forwards the unicast packet(s) to the BMSC.

8. Depending on where the sending automation unit of the broadcast messages is situated, the broadcast message is broadcast by the BMSC via the MBMS-GW into the pertinent broadcast area.

### BRIEF DESCRIPTION OF THE DRAWINGS

FIG. 1 shows a first embodiment of a method for communicating broadcast messages between clients in a communication network;

FIG. 2 shows a second embodiment of a method for communicating broadcast messages between clients in a communication network;

FIG. 3 shows a schematic block diagram of a first embodiment of a system for communicating broadcast messages between clients in a communication network;

FIG. 4 shows a schematic block diagram of a second embodiment of a system for communicating broadcast messages between clients in a communication network; and

FIG. 5 shows a schematic block diagram of an embodiment of a service center for communicating broadcast messages between clients in a communication network.

In the Figures, like reference numerals designate like or functionally equivalent elements, unless otherwise indicated.

### DETAILED DESCRIPTION

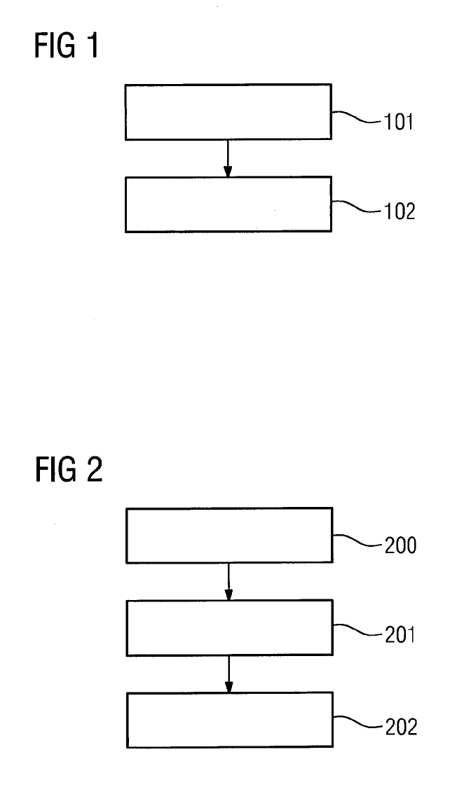

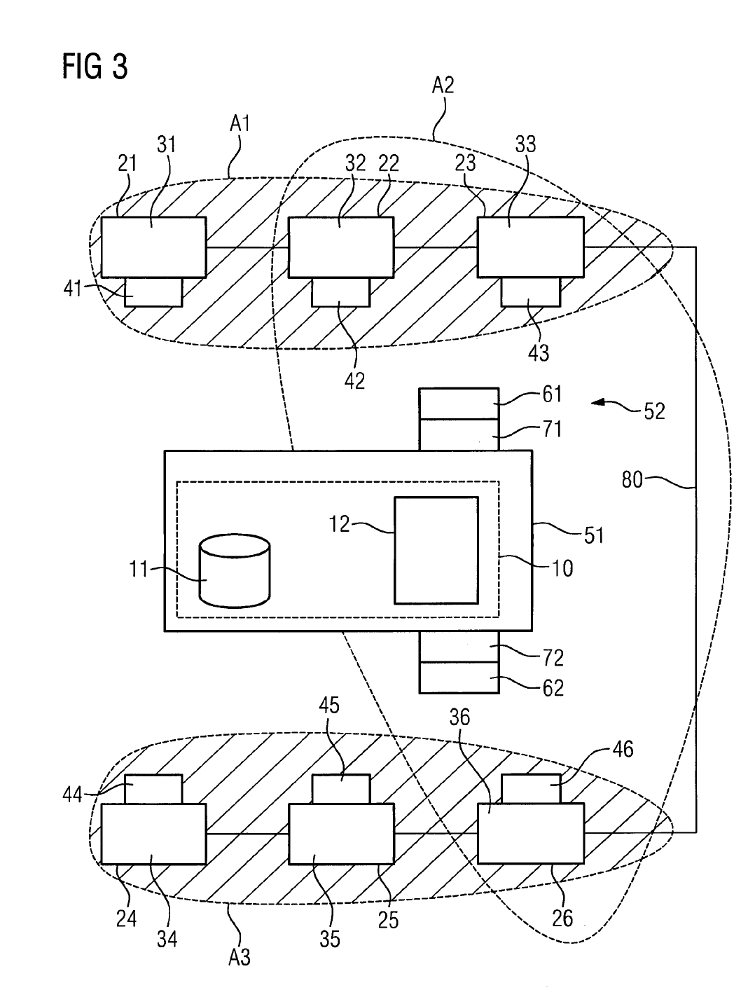

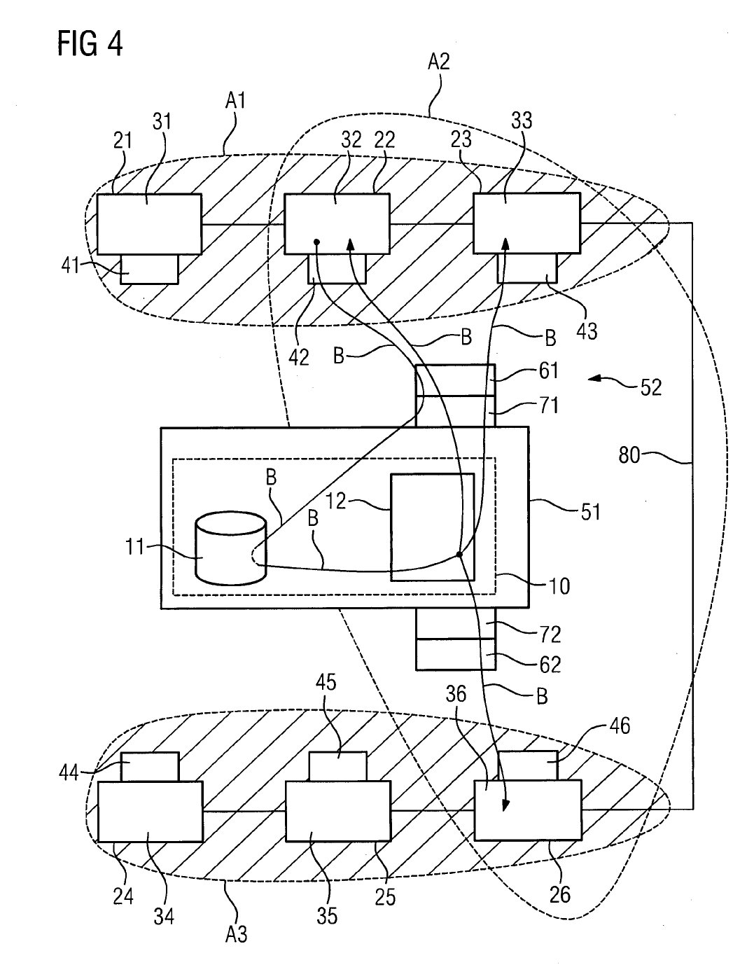

FIGS. 1 and 2 show embodiments for a method for communicating broadcast messages B between clients 21-26 in a communication network 51, 52. FIGS. 3 and 4 show embodiments of a system for communicating the broadcast messages B, in which the methods of FIGS. 1 and 2 may be applied, respectively. In this regard, the embodiments of the methods according to FIGS. 1 and 2 are explained with reference to FIGS. 3 and 4. FIGS. 3 and 4 are equivalent to each other, where FIG. 4 also shows the flow of a broadcast message B from a sending client 22 to receiving clients 22, 23, 26.

The architecture of the system of FIGS. 3 and 4 is as follows: The system of FIGS. 3 and 4 includes a communication network 51, 52 having a core mobile network 51 and a wireless mobile network 52 (N≧1). Without loss of generality, FIGS. 3 and 4 show one single wireless mobile network 52 (N=1), which may be embodied as an LTE network. The core mobile network 51 includes a service center 10 having a BMSC 11 and a MBMS-GW 12. Further, the core mobile network 51 has a number of base stations 61, 62 and local gateways 71, 72. For example, the respective base station 61, 62 may be an eNodeB.

Further, in the system of FIGS. 3 and 4, there are six clients 21-26. Each client 21-26 includes an automation unit 31-36 and a modem 41-46. The clients 21-26 are coupled by a medium-voltage distribution network 80. Each of the clients 21-26 is allocated or mapped to one broadcast area A1-A3 covered by the wireless mobile network 52. In the example of FIGS. 3 and 4, the three clients 21-23 are allocated to a first broadcast area A1. The three clients 22, 23, 26 are allocated to a second broadcast area A2. The three clients 24, 25, 26 are allocated to a third broadcast area A3.

FIG. 1 shows a first embodiment of a sequence of method acts for communicating broadcast messages B between clients 21-26 in a communication network 51, 52 having a core mobile network 51 and a number N (N≧1) of wireless mobile networks 52. Each of the clients 21-26 is coupled to the core mobile network 51 by at least one of the N wireless mobile networks 52.

The method of FIG. 1 includes the following acts 101 and 102.

In act 101, a broadcast message B is sent from a sending client 22 of the clients 21-26 via unicast to a service center 10 of the core mobile network 51.

In act 102, the broadcast message B is transmitted from the service center 10 via broadcast to a plurality of the clients 22, 23, 26 using at least a subset of the N wireless mobile networks 52.

FIG. 2 shows a second embodiment of a sequence of method acts for communicating broadcast messages B between clients 21-26 in a communication network 51, 52.

The method of FIG. 2 includes the following acts 200, 201, and 202.

In act 200, each of the clients 21-26 is allocated to at minimum one broadcast area A1-A3 of a plurality of broadcast areas A1-A3 covered by the wireless mobile network 52. The act of allocating may use mapping indications of the clients 21-26, identifiers of the clients 21-26, or geographic locations of the clients 21-26. The allocation may be done, for example, as shown in FIGS. 3 and 4.

In act 201, a broadcast message B is sent from a sending client, the client 22 in FIG. 4, via unicast to the service center 10 of the core mobile network 51.

In act 202, the broadcast message B received from the sending client 22 being allocated to the second broadcast area A2 is transmitted from the service center 10 via broadcast to the further clients 22, 23, 26 allocated to the second broadcast area A2.

For example, the traffic for the broadcast areas A1-A3 may be shaped. For example, for each of the broadcast areas A1-A3, the number of subframes may be adjusted within a radio frame dedicated to the respective broadcast area A1-A3.

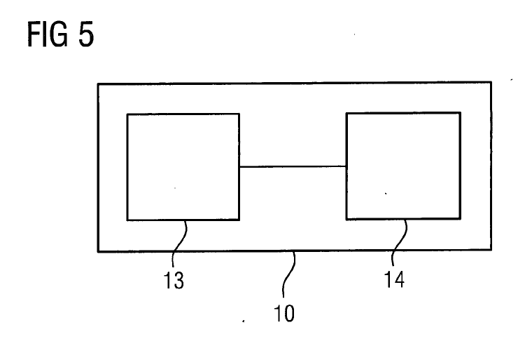

FIG. 5 shows a schematic block diagram of an embodiment of the service center 10 for communicating broadcast messages B between clients 21-26 in a communication network 51, 52 having a core mobile network 51 and a number N of wireless mobile networks 52. Each of the clients 21-26 is coupled to the core mobile network 51 by one of the N wireless mobile networks 52.

The service center 10 of FIG. 5 includes a receiving unit 13 and a transmitting unit 14.

The receiving unit 13 is configured to receive a broadcast message B sent from a sending client 22 (see FIG. 4) of the clients 21-26 via unicast.

The transmitting unit 14 is configured to transmit the broadcast message B via broadcast to a plurality of the clients 22, 23, 26 (see FIG. 4) using at least a subset of the N wireless mobile networks 52. For example, the receiving unit 14 may be part of the BMSC 11 of FIGS. 3 and 4, where the transmitting unit 14 may be part of the MBMS-GW 12 of FIGS. 3 and 4.

Although the present invention has been described in accordance with exemplary embodiments, modifications are possible in all embodiments.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for communicating broadcast messages between clients in a communication network having a core mobile network and a number of wireless mobile networks, wherein each of the clients is coupled to the core mobile network by one of the wireless mobile networks, the method comprising:
sending a broadcast message from a sending client of the clients via unicast to a service center of the core mobile network; and
transmitting the broadcast message from the service center via broadcast to a plurality of the clients using at least a subset of the wireless mobile networks.

2. The method of claim 1, wherein the service center includes a broadcast multicast service center, a multimedia broadcast multicast service gateway, or the broadcast multicast service center and the multimedia broadcast multicast service gateway.

3. The method of claim 2, wherein sending the broadcast message comprises sending the broadcast message from the sending client over a local gateway or a packet data network gateway to the broadcast multicast service center.

4. The method of claim 2, wherein transmitting the broadcast message comprises transmitting the broadcast message from the broadcast multicast service center to the clients over the multimedia broadcast multicast service gateway.

5. The method of claim 1, further comprising:
allocating each of the clients to one broadcast area of a plurality of broadcast areas covered by the wireless mobile networks.

6. The method of claim 5, further comprising:
transmitting the broadcast message received from the sending client, which is allocated to a certain broadcast area of the plurality of broadcast areas, from the service center via broadcast to the clients allocated to the certain broadcast area.

7. The method of claim 6, further comprising:
filtering the broadcast message broadcast to the clients allocated to the certain broadcast area such that the broadcast message reaches all the clients allocated to the certain broadcast area excluding the sending client.

8. The method of claim 5, wherein the allocating includes:
sending a mapping indication from a certain client of the clients to the service center, wherein the mapping indication indicates a certain broadcast area the certain client wants to join;
receiving the mapping indication at the service center; and
mapping the certain client to the certain broadcast area using the received mapping indication.

9. The method of claim 8, wherein each of the clients includes an automation unit and a modem,
wherein the mapping indication is provided in dependence on the automation unit, and
wherein the provided mapping indication is transferred to the service center using the modem.

10. The method of claim 1, wherein the allocating includes:
sending an identifier of a certain client of the clients to the service center;
receiving the identifier at the service center; and
mapping the certain client to a certain broadcast area using the received identifier.

11. The method of claim 10, wherein each of the clients includes an automation unit and a modem,
wherein the certain client is mapped to the certain broadcast area using the received identifier identifying the automation unit, the modem, or the automation unit and the modem and using a directory,
wherein the directory lists the automation units, the modems, and allocated broadcast areas.

12. The method of claim 5, wherein the allocating includes:
providing a geographic location of a certain client of the clients to the service center;
receiving the geographic location at the service center; and
mapping the certain client to the certain broadcast area using the received geographic location.

13. The method of claim 1, further comprising:
shaping traffic for the plurality of broadcast areas.

14. The method of claim 13, further comprising:
for each of the broadcast areas, adjusting a number of subframes within a radio frame dedicated to the respective broadcast area.

15. A service center for communicating broadcast messages between clients in a communication network having a core mobile network and a number of wireless mobile networks, wherein each of the clients is coupled to the core mobile network by one of the wireless mobile networks, the service center comprising:
a receiver configured to receive a broadcast message sent from a sending client of the clients via unicast; and
a transmitter configured to transmit the broadcast message via broadcast to a plurality of the clients using at least a subset of the wireless mobile networks.

16. A system comprising:
a plurality of clients; and
a service center for communicating broadcast messages between clients in a communication network having a core mobile network and a number of wireless mobile networks, wherein each of the clients is coupled to the core mobile network by one of the wireless mobile networks, the service center comprising:
a receiver configured to receive a broadcast message sent from a sending client of the clients via unicast; and
a transmitter configured to transmit the broadcast message via broadcast to a plurality of the clients using at least a subset of the wireless mobile networks.
